(19) United States
(12) Patent Application Publication
(10) Pub. No.: US 2009/0082055 A1
(43) Pub. Date: Mar. 26, 2009

(54) Cordless telephone system

(75) Inventor: Karl-Heinz Mueller, Tsing Hi (HK)

Correspondence Address: COLLARD & ROE, P.C., 1077 NORTHERN BOULEVARD, ROSLYN, NY, 11576, US

(73) Assignee: CCT Telecom (HK) Limited

(21) Appl. No.: 11/903,306

(22) Filed: Sep. 21, 2007

(51) Int. Cl. H04Q 7/20

(52) U.S. Cl. 455/522

(57) ABSTRACT

A cordless telephone system consisting of a fixed station and at least one mobile station, both of which switch over to standby operation after a telephone conversation has been terminated, and correspond with one another at fixed intervals. Each mobile station is registered in the fixed station and can be addressed by the fixed station, and both the fixed and the mobile station each have a receiver circuit and a transmission circuit. The transmission power of the transmission amplifier can be set, at least in the fixed station, as a function of the number of connected mobile stations.

### BACKGROUND OF THE INVENTION

1. Field of the Invention

The invention relates to a cordless telephone system consisting of a fixed station and at least one mobile station, which both switch over to standby operation after a telephone conversation has been terminated, and correspond with one another at fixed intervals. Each mobile station is registered in the fixed station and can be addressed by the latter, and both the fixed and the mobile station each have a receiver circuit and a transmission circuit. The transmission power of the transmission amplifier can be set, at least in the fixed station, as a function of the number of connected mobile stations.

2. The Prior Art

A telephone system of the type stated is a telephone system designed according to the DECT standard (Digital European Cordless Telecommunications), for example. The system is standardized according to ETS 300 175. Telephone conversations can be conducted, and data can be transmitted, using such a telephone system. Because of the transmission power values established, the ranges between fixed station and mobile station within buildings lie between 20 m and 50 m, and outside up to 300 m. The DECT standard is multi-cell capable and supports processes such as roaming and handover. Also, transitions into the ISDN are implemented. A high voice quality is achieved on the basis of the ADPCM coding (Adaptive Pulse Code Modulation) that is used. The frequency range lies between 1,880 MHz and 1,900 MHz throughout Europe, with ten carrier frequencies at 1.8 MHz bandwidth per carrier. The TDMA (Time Division Multiple Access) method and the TDD (Time Division Duplex) method are used as transmission methods. Each carrier frequency works with 12 duplex or 24 simplex transmission channels; in total, 120 transmission channels, bi-directional. Several mobile devices can communicate with a base station and with one another at the same time, by means of time multiplex methods. Also, mobile parts can be registered on several base stations, and can then be reached by way of different telephone numbers. This function is called “multi-link” and predominantly used for cordless telecommunications systems. The basis for all voice applications in DECT is established in GAP (Generic Access Profile). A high level of transmission security, preventing listening in, results from the access methods used. For data transmission, there is the possibility of channel bundling, with n×24 kbit/s up to max. 552 kbit/s.

The base station is connected with the public telecommunications network or a private telephone network, for example by way of ISDN. The base station generally has a charging compartment for a mobile station, which is laid or set into the charging compartment for this purpose. The rechargeable batteries in the mobile station are charged by way of contacts. In the case of some base stations, other corded telecommunications terminals can also be connected, in addition to the cordless telephone, the “Handy”. The base station has at least one power supply, a connected or integrated charging device for the rechargeable batteries in the mobile station, a ringer, a DECT digital part, and an HF part having a receiver circuit and a transmission circuit, in order to be able to correspond with the connected or the connected addressable mobile stations. The transmission power is ≦250 Mwatt, in most instances 10 Mwatt per mobile station and fixed station. The mobile stations generally have the same basic structure. They furthermore have the necessary keypad, the display, and the analog part that they need in order to be able to carry out voice correspondence.

After a telephone conversation or data transmission, the fixed station and the mobile part that corresponds with the fixed station are put into standby operation. In this state, carrier signals are transmitted at defined intervals, and this leads to an ongoing expenditure of power. This leads to a relatively high consumption of electricity. Furthermore, it is considered to be unpleasant, or can actually result in disruption of other devices, if the base and mobile stations are operated at the relatively high power that is not necessary, in order to be able to address the mobile parts at a greater distance, as provided in the standard.

According to the standard, the base stations must correspond with the mobile stations at fixed intervals, in order to assure synchronization of all of the stations with the base station. For this purpose, a carrier signal is transmitted to all the mobile parts at full power (up to +25 dBm is allowed), at fixed intervals. This ensures that the mobile parts are frequency-synchronous with the base and therefore a telephone conversation can be conducted at any time, without first having to wait for synchronization while a radio link is established between the base station and the mobile part. However, the invention is not restricted to DECT telephone systems.

A power-saving circuit in a mobile device for wireless communication with a fixed reception/transmission station is known from DE 40 01 810 C2, in which an electric switching device is provided in the mobile station, which switches the latter to transmission operation when the device is turned on, and shuts the control voltage source off, at first. The control voltage is placed at such a potential that the end amplifier of the transmission circuit is fully opened. The control voltage generation circuit is only switched on once the device is switched to reception operation, by way of the switching device. After being turned on, the power supply source is switched to the transmission circuit by way of a change-over switch that can be controlled by means of phonetic sounds, which switch is controlled by the recognition circuit that gives off a switching signal upon detection of a definite or indefinite sound entered into the voice capsule or the microphone of the device. The switching signal is maintained over a predetermined period of time, and can be extended by means of additional sounds.

### SUMMARY OF THE INVENTION

It is an object of the invention to significantly reduce the transmission power both in the fixed station and in the mobile station, particularly if no telephone conversation is being conducted or no data transmission is taking place.

This task is accomplished by a mobile telephone system, consisting of a fixed station and at least one mobile station, which both switch over to standby operation after a telephone conversation has been terminated, and correspond with one another at fixed intervals. Each mobile station is registered in the fixed station and can be addressed by the fixed station, and both the fixed and the mobile station each have a receiver circuit and a transmission circuit. The transmission power of the transmission amplifier can be set, at least in the fixed station, as a function of the number of connected mobile stations.

The invention proceeds from the recognition that if only one individual mobile station is coupled with a fixed station, for example, the mobile station is generally situated in the closer vicinity of the fixed station, since it can also be placed into a charging compartment there, in order to charge the rechargeable batteries. At lesser distances between the fixed station and the mobile station, the transmission power that is usually present and emitted is not required to maintain communication both in standby operation and in normal telephone operation. The transmission power could therefore be significantly reduced. This results not only in a reduction of the power consumption of the mobile part, but also in a reduction of the radiation intensity of the transmission stages, both in the fixed station and in the mobile part. Thus, if the fixed station determines that only a single mobile part is connected, the microprocessor contained in the fixed station brings it about, using a program written into it, that the transmission power is significantly lowered as compared with that required according to the standard. In this connection, the carrier signal that is transmitted at the fixed intervals can be reduced in level by 50%, i.e. almost 70 dBm.

The evaluation circuit in the fixed station therefore first determines, according to the invention, how many mobile stations are connected, and then reduces the transmission power, for example using a table that has been input, to an imaginary minimum, on the basis of the number of mobile stations. For this purpose, the microprocessor of the base station can also be used as the evaluation circuit. Communication is assured with this transmission power. The setting of the transmission power therefore takes place as a function of the number of mobile stations that are registered. If several mobile parts are registered, the transmission power of the carrier signal emitted is reduced to specific values that lie between the least transmission power for only one mobile station and the maximal equipment, for example with six mobile stations. If only one mobile part is registered, and if the mobile part is on the charging holder in the rest state or standby state, for example, the HF power is reduced by approximately 70 dBm, for example, and the synchronization between mobile part and base part is functioning just enough so that communication can be established at a later time, if a call comes in, or if a connection can be established from the mobile station. As soon as a call comes in and the mobile part is taken off the charging holder or turned on, the transmission power is increased to 50%. If several mobile parts are registered, then the base automatically switches to 50% transmission power of the carrier signal, for example, or to another value from the table, in order to assure communication of the mobile part and the base station.

The transmission power of the mobile station can be reduced in the same manner, or controlled by a control signal that is transmitted by the base station. This control signal can also be established as a function of the number of mobile stations, in order to be able to communicate between the mobile stations.

In another embodiment of the invention, the transmission power can also be set or regulated, in addition, as a function of the distance of the most remote mobile station. For this purpose, a field intensity measurement device that determines the reception field intensity received from a mobile station can be provided, which device measures the field intensity of the signal and makes the value available to the microprocessor for evaluation. The microprocessor establishes the setting value for the transmission stage in the fixed station and/or in the mobile station as a function of the number of the mobile stations and their distance, in order to determine the amplification factor of the end amplifier.

Also, a field intensity measurement device can be provided in each mobile station, in order to be able to adapt the transmission power of the mobile station to the distance from the base station by means of measuring the field intensity. The aim is always to apply the lowest possible transmission power. It has been shown that in this way, the standby operation and the normal period of use of a mobile station can be significantly increased.

The fixed station can also give off a signal to each addressed mobile station, to control the transmission power of the mobile station as a function of the minimum field intensity, to control the transmission amplifiers in the mobile station. This intensity is evaluated by the microprocessor of the mobile station and stored in a corresponding memory, to control the transmission amplifier, the output value of which memory serves to regulate the control of the end amplifier.

In another embodiment, in the case of reduced transmission power, the range is assured at least during transmission of the carrier signals, at fixed intervals. For this purpose, low noise amplifiers (LNAs) can additionally be used in the mobile parts, which increase the sensitivity to such an extent that even at 50% transmission power of the end amplifier circuit in the fixed station, for example, a desired maximal range is achieved. The invention makes it possible to achieve an energy management that leads to a longer period of use of a mobile station during discharging of the rechargeable battery, and furthermore, the radiation emitted by the mobile and fixed stations is significantly reduced.

### BRIEF DESCRIPTION OF THE DRAWINGS

The invention will be described supplementally below, using the block schematics of a base (fixed) station and a mobile station of a DECT telephone system shown in the drawings. It is to be understood, however, that the drawings are designed as an illustration only and not as a definition of the limits of the invention.

In the drawings:

FIG. 1 shows a block schematic of a base station or fixed station; and

FIG. 2 shows a block schematic of a mobile station.

### DETAILED DESCRIPTION OF THE PREFERRED EMBODIMENT

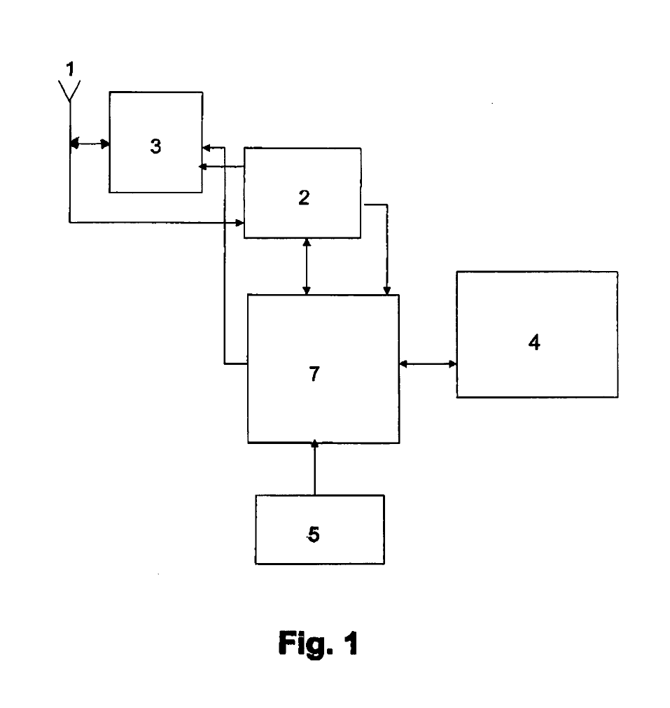

Referring now in detail to the drawings, the base station in FIG. 1 has a transmission and reception antenna 1. Reception antenna 1 is connected with the receiver circuit of DECT transceiver 2, and with transmission amplifier 3, the power of which can be adjusted variably. DECT transceiver 2 is controlled by a base band microprocessor 7, which has access to a memory 4 in which the programs for control of the base station are stored, among them a control table for controlling the transmission power as a function of the number of connected mobile stations. Furthermore, a control table can supplementally be provided, which contains corrective amplification factors on the basis of measured field intensities. Furthermore, the base station has a charge recognition 5, which determines whether or not an individual mobile station is turned on, and whether the latter is situated in the vicinity of the base station or on the mobile station itself, in a charging holder.

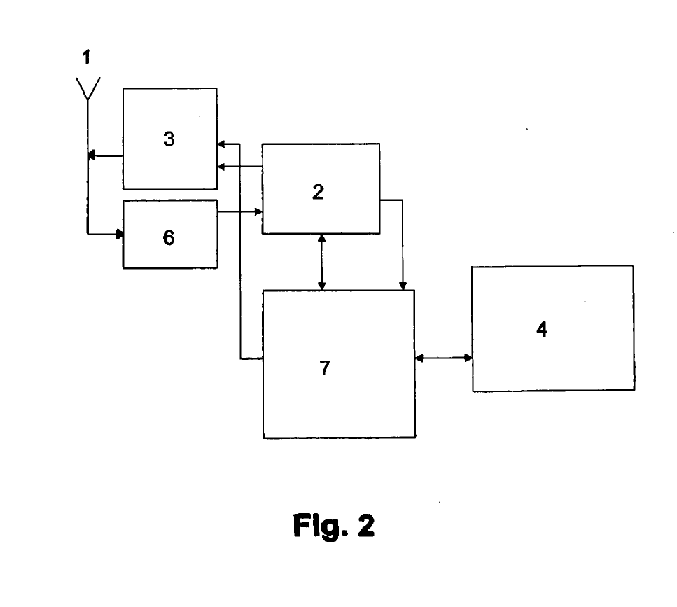

The transmission power of transmission amplifier 3 is controlled, according to the invention, as a function of the factors contained in the control table(s). If only one mobile station is present, the transmission power is reduced to 50%, for example. If, in addition, a field intensity measurement is carried out, in order to determine the transmission power of the mobile station that is shown in FIG. 2, the transmission power can be reduced yet again, in adapted manner. In corresponding manner, however, the transmission power can also be reduced in the mobile station, if a data exchange between the stations takes place with regard to the field intensities determined. If the result of the field intensity measurement is reported to another station, which can also be another mobile station directly called by a mobile station, the transmission powers of the two stations can be searched up to a level that is just sufficient for communication.

The mobile station in FIG. 2 also has an antenna 1. A reception amplifier (LNA) 6 is connected with antenna 1, which amplifier in turn is connected with DECT transceiver 2, in order to be able to receive, evaluate, and acoustically reproduce the signals by way of an earpiece, not shown. Likewise, the microphone that is required for voice input, or the keypad for data input, is not shown. The mobile station also has a base band microprocessor 7 that accesses a memory 4, in which the programs of the mobile station are stored, among them a control table for the transmission power as a function of the measured field intensity and/or the possible mobile stations that can be included in communication. It is possible to continuously reduce the transmission power, in addition, up to a level that is just sufficient for correspondence between the two devices, by measuring the field intensity. The transmission power is controlled by way of an amplifier 3 that receives the control signals from microprocessor 7.

Accordingly, while only a few embodiments of the present invention have been shown and described, it is obvious that many changes and modifications may be made thereunto without departing from the spirit and scope of the invention.

What is claimed is:

1. A cordless telephone system comprising:
a fixed station; and
at least one mobile station, said fixed and mobile stations switching over to standby operation after a telephone conversation has been terminated, and corresponding with one another at fixed intervals, each mobile station being registered in the fixed station and adapted to be addressed by the fixed station,
wherein both the fixed and the mobile station each have a receiver circuit and a transmission circuit, and wherein transmission power of a transmission amplifier in the transmission circuit can be set, at least in the fixed station, as a function of a number of connected mobile stations.

2. A cordless telephone system according to claim 1, wherein the transmission power is set or can be regulated as a function of a distance of the most remote mobile station from the fixed station.

3. A cordless telephone system according to claim 1, wherein the transmission circuit of the fixed station has a controllable transmission amplifier, amplification of which is controlled by a microprocessor, as a function of the number of mobile stations and their distance from the fixed station.

4. A cordless telephone system according to claim 3, wherein a field intensity measurement device is integrated at least into the fixed station, said device detecting field intensity of a transmitter of at least one mobile station, and reducing transmission power of the transmission circuit in the fixed station to a minimum, as a function of said field intensity.

5. A cordless telephone system according to claim 1, wherein a field intensity measurement device is present in each mobile station, and wherein transmission power of the mobile station is reduced to a point where the transmission power is just sufficient for communication with the fixed station, but assures synchronization between the stations and communication.

6. A cordless telephone system according to claim 1, wherein the fixed station gives off a signal to each addressed mobile station, to control transmission power of the mobile station as a function of minimum field intensity, to control the transmission amplifiers in the mobile stations.

7. A cordless telephone system according to claim 1, wherein an LNA is provided in the receiver circuit of the mobile station, said LNA increasing sensitivity of the receiver circuit, at least in standby operation.

8. A cordless telephone system according to claim 1, wherein the telephone system is a DECT telephone system.

9. A cordless telephone system according to claim 1, wherein transmission power amplification factors are stored in a memory at least in the base station, in table form, assigned to the number of mobile stations, and further comprising a microprocessor in the base station that outputs the factor to the transmission amplifier, as a function of the number of connected mobile stations actually determined.

10. A cordless telephone system according to claim 9, wherein the stored values are output and changed as a function of a measured field intensity of a signal received by a mobile station.
